(19) United States
(12) Patent Application Publication
(10) Pub. No.: US 2003/0220418 A1
(43) Pub. Date: Nov. 27, 2003

(54) Image forming method using oil-based ink composition

(75) Inventors: Seiji Horie, Shizuoka (JP); Yutaka Sakasai, Shizuoka (JP)

Correspondence Address: BURNS, DOANE, SWECKER & MATHIS, L.L.P., P.O. Box 1404, Alexandria, VA, 22313-1404, US

(73) Assignee: FUJI PHOTO FILM CO., LTD.

(21) Appl. No.: 10/417,176

(22) Filed: Apr. 17, 2003

(30) Foreign Application Priority Data
Apr. 18, 2002 (JP) P.2002-116139
Jul. 10, 2002 (JP) P.2002-201431

(51) Int. Cl. C03C 17/00; C09D 5/00

(52) U.S. Cl. 523/160; 523/161

(57) ABSTRACT

An image forming method comprising ejecting an oil-based ink composition comprising: a non-aqueous dispersion medium; a coloring material; and a binder resin comprising a graft copolymer, wherein the graft copolymer comprises a monomer constituting a main chain moiety soluble in the non-aqueous dispersion medium and a macro monomer constituting a graft moiety insoluble in the non-aqueous dispersion medium.

### FIELD OF THE INVENTION

The present invention relates to an oil-based ink composition for use in an ink jet recording device which causes an ink to fly to record letters and images on a transferring medium such as recording paper and an image forming method using same and more particularly to an oil-based ink composition comprising a pigment dispersion in a non-aqueous dispersion medium and an image forming method using same.

### BACKGROUND OF THE INVENTION

Heretofore, ink jet recording processes have been roughly divided into two groups, i. e., continuance type in which ink particles are continuously generated while being controlled over the electrostatic charge of the ink particles required for the formation of an image and then passed in an electric field formed between polarizing electrodes while being controlled over the flying orbit of the ink particles and on-demand type in which an ink is ejected only when necessary for printing.

As inks to be used in this ink jet recording process there are mainly used inks having various aqueous dyes dissolved in water or a solvent made of water and a water-soluble organic solvent and optionally various additives incorporated therein (hereinafter referred to as “aqueous dye inks”). However, when such aqueous dye inks are used for printing, many defectives occur. For example, the inks run on some recording papers, making it impossible to obtain a high quality print. Further, the recorded image thus formed exhibits deteriorated water resistance and light-resistance. Moreover, the inks are slowly dried on the recording paper, causing running. Further, possible color stain (color turbidity or unevenness occurring at color interface when different color dots are printed adjacent to each other) causes deterioration of quality of recorded image.

In order to improve the water resistance and light-resistance of recorded image, which are weak points of aqueous dye inks as mentioned above, various attempts to apply an pigment-based ink having pigment particles finely dispersed in an aqueous dispersion medium or non-aqueous dispersion medium to an ink jet recording process have been made. For example, an ink for ink jet printer having pigment particles dispersed in a dispersion medium mainly composed of water is proposed in JP-A-2-255875, JP-A-3-76767, JP-A-3-76768, JP-A-56-147871 and JP-A-56-147868. However, since the pigment is insoluble in the medium, it is normally disadvantageous in that the ink exhibits a poor dispersion stability and causes clogging in nozzle.

On the other hand, an ink comprising pigment particles dispersed in a non-polar insulating solvent (hereinafter referred to as “oil-based pigment ink”) is advantageous in that it can be easily absorbed by the paper and thus causes little running and gives a recorded image having a good water resistance. For example, inks as disclosed in JP-A-57-10660 and JP-A-57-10661 have been proposed. JP-A-57-10660 discloses that the pigment is finely dispersed in the medium with an alcohol amide-based dispersant. JP-A-57-10661 discloses that the pigment is finely dispersed in the medium with a sorbitan-based dispersant. However, since the pigment particles cannot be thoroughly uniformly and finely dispersed in a non-polar insulating solvent and has a poor dispersion stability, it is still disadvantageous in that the ink causes nozzle clogging. Further, since the pigment itself has no fix ability to the recording paper, it is greatly disadvantageous in that the ink has an insufficient scratch resistance.

In order to eliminate these difficulties, a resin-dissolved oil-based ink comprising a resin soluble in a non-polar insulating solvent both as a fixing agent and a pigment dispersant has been proposed. For example, JP-A-3-234772 proposes an oil-based ink having pigment particles coated with a resin by microcapsulizing method or the like. However, since the pigment-encapsulated resin particles can be difficultly finely dispersed in the solvent and has an insufficient dispersion stability, the resulting ink has a reliability problem. In recent years, high quality photographic image has been realized with an ordinary ink jet printer using aqueous dye inks. It has thus been desired to atomize pigments as much as possible and keep the pigment particles stably dispersed in the solvent for the purpose of enhancing the color developability and transparency of pigment inks.

On the other hand, however, as the pigment is further atomized, the primary pigment particles are ruptured. Further, the resulting increase of surface energy is accompanied by the increase of cohesive energy that causes recohesion, finally resulting in defectives such as deterioration of storage stability of the pigment dispersion thus atomized. Thus, it has been desired that the pigment dispersion to be incorporated in the oil-based pigment ink for ink jet printer be further atomized. However, the fine dispersion of pigment requires high technique. At the same time, it is very difficult to enhance the dispersion stability of pigment. It has thus been desired to provide an oil-based pigment ink which satisfies the aforementioned requirements.

Further, the binder resin with which the coloring material is dispersed and coated is normally desired to satisfy various requirements that (1) the surface of the pigment be thoroughly coated to form a colored mixture that gives a proper fluidity upon heating, (2) the coloring material thus coated can be fairly dispersed in the dispersion medium, (3) the binder resin be as transparent as possible and (4) the binder resin be firmly fixed to the recording medium to give a sufficient scratch resistance.

From the standpoint of these requirements of binder resin, i.e., capability of being adsorbed to the coloring material to cause the coloring material to be fairly dispersed in the dispersion medium and capability of being fixed to the recording medium to give a sufficient scratch resistance, it is considered ideal that the binder resin is essentially composed of a component which can be solvated to the dispersion medium and a component which can be difficultly solvated to the dispersion medium and even further a component having a polar group. It has been difficult to find a binder resin which satisfies these requirements.

### SUMMARY OF THE INVENTION

The first aim of the invention is to provide an oil-based composition for ink jet printer which has pigment particles finely dispersed therein and exhibits an excellent pigment dispersion stability to cause no nozzle clogging and give a high ejection stability.

The second aim of the invention is to provide an oil-based composition for ink jet printer which exhibits an excellent dryability on the recording paper and gives a recorded image having an excellent water resistance and light-resistance and a high scratch resistance. The third aim of the invention is to provide an oil-based composition for ink jet printer which allows printing of a number of sheets of printed matter of sharp color image having excellent optical characteristics.

The inventors made extensive studies of solution to these problems. As a result, it was found that the aforementioned aims of the invention are accomplished by the following constitutions.

(1) An oil-based composition for ink jet printer comprising at least a coloring material and a binder resin incorporated in a non-aqueous dispersion medium, wherein the binder resin comprises at least one of monomers constituting a main chainmoiety soluble in the non-aqueous dispersion medium and at least one of macromonomers constituting a graft moiety (side chain moiety) insoluble in the non-aqueous dispersion medium incorporated therein.

(2) The oil-based composition for ink jet printer as defined in Clause (1), wherein the monomer constituting the main chain moiety soluble in the non-aqueous dispersion medium is a monomer represented by the following formula (III) and the macro monomer is a macro monomer having a weight-average molecular weight of from 1×10³ to 4×10⁴ and having a main chain containing at least one of repeating units represented by the following formulae (IIa) and (IIb) having a polymerizable double bond represented by the following formula (I) at one end thereof (with the proviso that the polymer containing at least one of repeating units represented by the following formulae (IIa) and (IIb) is insoluble in the non-aqueous dispersion medium):

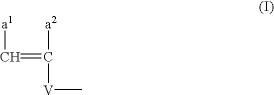

wherein V represents —COO—, —OCO—, —(CH₂)ₙ—OCO—, —(CH₂)ₙ—COO—, —O—, —CONHCOO—, —CONHCO—, —SO₂—, —CO—, —CON(Z¹)—, —SO₂N(Z¹)— or phenylene group (in which phenylene group will be hereinafter represented by Ph, with the proviso that Ph may be 1,2-, 1,3- or 1,4-phenylene group), Z1 represents a hydrogen atom or hydrocarbon group, and n represents an integer of from 1 to 3); and a¹ and a² may be the same or different and each represent a hydrogen atom, a halogen atom, a cyano group, a hydrocarbon group, —COO—Z² or —COO—Z² having a hydrocarbon group incorporated therein (in which Z² represents a hydrogen atom or hydrocarbon group);

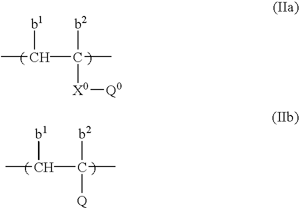

wherein X⁰ represents at least one connecting group (linking group) selected from —COO—, —OCO—, —(CH₂)ₘ—OCO—, —(CH₂)ₘ—COO—, —O—, —CONHCOO—, —CONHCO—, —SO₂—, —CO—, —CON(Z³)— and —SO₂N (Z³)— (in which Z³ represents a hydrogen atom or hydrocarbon group, and m represents an integer of from 1 to 3); b¹ and b² may be the same or different and have the same meaning as a¹ and a²in the formula (I), respectively; Q⁰ represents a C₁-C₃ aliphatic group, C₃-C₈ cycloalkyl group or crosslinked hydrocarbon group; and Q represents —CN or a phenyl group which may be substituted by substituents such as halogen atom, alkoxy group and —COO—Z⁴ (in which Z⁴ represents a hydrogen atom, alkyl group, alkenyl group, aralkyl group, alicyclic group or aryl group);

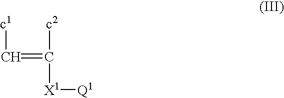

wherein X¹ has the same meaning as V in the formula (I); Q1 represents a C₄-C₂₂ aliphatic group; and c¹ and c² may be the same or different and have the same meaning as a¹ and a² in the formula (I), respectively.

(3) The oil-based composition for ink jet printer as defined in Clause 1 or 2, further comprising a pigment dispersant incorporated in the non-aqueous dispersion medium.

(4) An image forming method employing an ink jet recording process using an oil-based composition for ink jet printer as defined in Clause 1.

The oil-based composition for ink jet printer of the invention comprises a binder resin and a coloring material incorporated therein as main components. The coloring material is dispersed (mixed with) in the binder resin. As a result, the coloring material is coated with the binder resin.

The graft copolymer of the invention itself has been already disclosed in JP-A-4-350669, JP-A-5-188657, and JP-A-3-188469. In JP-A-4-350669 and JP-A-5-188657, however, the graft copolymer is used as a dispersion polymerization dispersant for particulate resin-based liquid developer. In JP-A-3-188469, the graft copolymer is used as a non-aqueous pigment dispersant. None of these patents refer to the fact that the graft copolymer of the invention can be fairly used as a binder resin for providing a coloring material with dispersibility, fix ability and scratch resistance as in the invention.

### DETAILED DESCRIPTION OF THE INVENTION

The invention will be further described hereinafter.

Firstly, the graft copolymer to be used as a binder resin will be further described below.

The graft copolymer of the invention comprises at least one of monomers constituting a main chain moiety soluble in the non-aqueous dispersion medium (hereinafter occasionally referred to as “monomer (S)”) and at least one of macromonomers constituting a graft moiety (side chain moiety) insoluble in the non-aqueous dispersion medium (hereinafter occasionally referred to as “monomer (M)”) incorporated therein.

The monomer (S) is a monomer which renders the polymer containing the monomer (S) soluble in the non-aqueous dispersion medium. The monomer (S) constitutes a main chain moiety soluble in the non-aqueous dispersion medium in the graft copolymer obtained by the copolymerization with the macro monomer (M). Specific examples of the monomer (S) include monomers represented by the formula (III).

The macromonomer (M) is a macromonomer having a side chain moiety insoluble in the non-aqueous dispersion medium and constitutes a graft moiety insoluble in the non-aqueous dispersion medium in the graft copolymer obtained by the copolymerization with the monomer (S). In some detail, the macromonomer (M) is preferably a macromonomer having a weight-average molecular weight of from 1×10³ to 4×10⁴ comprising a polymer main chain containing at least one of repeating units represented by the formulae (IIa) and (IIb) having a polymerizable double bond group represented by the formula (I) copolymerizable with the monomer (S) at one end thereof. The polymer containing at least one of repeating units represented by the formulae (IIa) and (IIb) is insoluble in the non-aqueous dispersion medium.

In the formulae (I), (IIa) and (IIb), the hydrocarbon groups contained in a¹, a², V, b¹, b², X⁰, Q⁰ and Q each have carbon atoms (as unsubstituted hydrocarbon groups ) by the defined number. These hydrocarbon groups may be substituted.

In the formula (I), Z¹ in the substituent represented by V is a hydrogen atom or hydrocarbon group. Preferred examples of the hydrocarbon group include C₁-C₂₂ alkyl group which may be substituted (e.g., methyl group, ethyl group, propyl group, heptyl group, hexyl group, octyl group, decyl group, dodecyl group, tridecyl group, tetradecyl group, hexadecyl group, octadecyl group, 2-chloroethyl group, 2-bromoethyl group, 2-cyanoethyl group, 2-methoxycarbonylethyl group, 2-methoxyethyl group, 2-bromopropyl group), C₄-C₁₈ alkenyl group which may be substituted (e.g., 2-methyl-1-propenyl group, 2-butenyl group, 2-pentenyl group, 3-methyl-2-pentenyl group, 1-pentenyl group, 1-hexenyl group, 2-hexenyl group, 4-methyl-2-hexenyl group), C₇-C₁₂ aralkyl group which may be substituted (e.g., benzyl group, phenethyl group, 3-phenylpropyl group, naphthylmethyl group, 2-naphthylethyl group, chlorobenzyl group, bromobenzyl group, methylbenzyl group, ethylbenzyl group, methoxybenzyl group, dimethylbenzyl group, dimethoxybenzyl group), C₅-C₈ alicyclic group which may be substituted (e.g., cyclohexyl group, 2-cyclohexylethyl group, 2-cyclopentylethyl group), C₆-C₁₂ aromatic group which may be substituted (e.g., phenyl group, naphthyl group, tolyl group, xylyl group, propylphenyl group, butylphenyl group, octylphenyl group, dodecylphenyl group, methoxyphenyl group, ethoxyphenyl group, butoxyphenyl group, decyloxyphenyl group, chlorophenyl group, dichlorophenyl group, bromophenyl group, cyanophenyl group, acetylphenyl group, methoxycarbonylphenyl group, ethoxycarbonylphenyl group, butoxycarbonylphenyl group, acetamidephenyl group, propioamidephenyl group, dodecyloylamidephenyl group), and group comprising C₅-C₁₈ crosslinked hydrocarbon (e.g., bicyclo[1,1,0]butane, bicyclo[3,2,1, ]octane, bicyclo[5,2,0]nonane, bicyclo[4,3,2]undecane, adamanthane).

The benzene ring —C₆H₄— represented by V may have substituents. Examples of the substituents include halogen atom (e.g., chlorine atom, bromine atom), andalkyl group (e.g. ,methyl group, ethyl group, propyl group, butyl group, chloromethyl group, methoxymethyl group).

The suffixes a¹ and a² may be the same or different and each preferably represent a hydrogen atom, a halogen atom (e. g., chlorine atom, bromine atom), a cyano group, a C₁-C₃ alkyl group (e.g., methyl group, ethyl group, propyl group), —COO—Z² or —CH₂COOZ² (in which Z² preferably represents a hydrogen atom or C₁-C₁₈ alkyl group, alkenyl group, aralkyl group, alicyclic group or aryl group which may be substituted (Specific examples of these groups include those exemplified with reference to Z¹)).

In the formula (IIa) or (IIb), X⁰ represents at least one connecting group selected from —COO—, —OCO—, —(CH₂)ₘ—OCO—, —(CH₂)ₘ—COO—, —O—, —CONHCOO—, —CONHCO—, —SO₂—, —CO—, —CON(Z³)— and —SO₂N(Z³)—. Z³ represents a hydrogen atom or hydrocarbon group. Specific examples of the hydrocarbon group include those exemplified with reference to Z¹. The suffix m represents an integer of from 1 to 3.

The suffixes b¹ and b² may be the same or different and have the same meaning as a¹ and a² in the formula (I), respectively. The preferred range of b¹ and b² is the same as that described with reference to a¹ and a².

Q⁰ represents a C₁-C₃ aliphatic group, C₃-C₈ cycloalkyl group or crosslinked hydrocarbon group.

Q represents —CN or a phenyl group which may be substituted by substituents such as halogen atom, alkoxy group and —COO—Z⁴ (in which Z⁴ represents a hydrogen atom, alkyl group, alkenyl group, aralkyl group, alicyclic group or aryl group).

Z⁴ preferably represents a hydrogen atom or a C₁-C₁₈ alkyl group, alkenyl group, aralkyl group, alicyclic group or aryl group which may be substituted. Specific examples of these groups include those described with reference to Z¹.

Even more desirable examples of a¹ and a² in the formula (I) or b¹ and b² in the formulae (IIa) and (IIb) include hydrogen atom and methyl group.

The repeating unit in the macro monomer (M) of the invention preferably contains at least one of repeating units represented by the formulae (IIa) and/or (IIb). Specific examples of the repeating unit will be given below, but the invention is not limited thereto. In the following examples, b represents H or —CH₃, Q² represents a methyl, ethyl or propyl group, Q³ represents a halogen atom, an alkyl group, an aralkyl group, an alkoxy group or —CO₂—Z³, and Q⁴ represents a C₁-C₁₂ alkyl group.

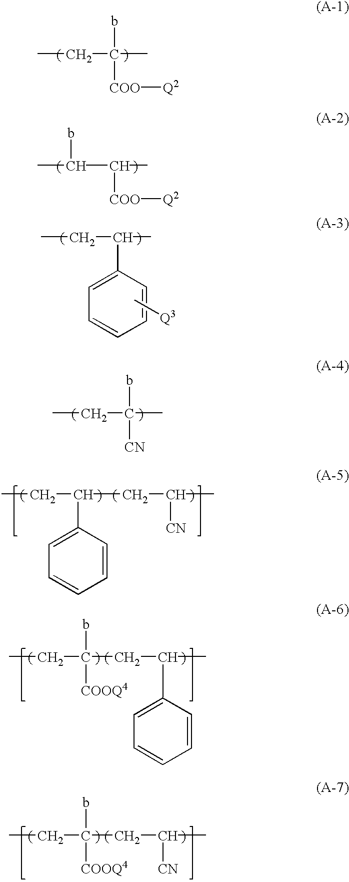

The macromonomer (M) of the invention is preferably represented by the following formula (IV).

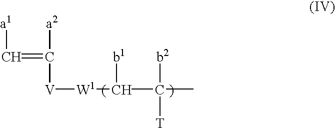

In the formula (IV), a¹, a², b¹, b² and V are as defined in the formulae (I), (IIa) and (IIb).

T represents —X⁰—Q⁰ group represented by the formula (IIa) or —Q group represented by the formula (IIb). These groups are as defined in the formulae (IIa) and (IIb).

W¹ represents a single bond or a connecting group selected from the group consisting of atomic groups such as —C(Z⁶) (Z⁷)—[Z⁶ and Z⁷ each represent a hydrogen atom, halogen atom (e.g., fluorine atom, chlorineatom, bromine), cyano group, hydroxyl group], —(CH═CH)—, cyclohexylene group (hereinafter represented by Cy which may be 1,2-, 1,3- or 1,4-cyclohexylene group), —Ph—, —O—, —S—, —C(═O)—, —N (Z⁸)—, —COO—, —SO₂—, —CON(Z⁸)—, —SO₂N(Z⁸)—, —NHCOO—, —NHCONH— and—Si(Z⁸)(Z⁹)—[Z⁸ and Z⁹ each represent a hydrogen atom, the same hydrocarbon group as exemplified with reference to Z¹] or a connecting group formed by some of these atomic groups in combination.

Preferred examples of X⁰, V, a¹, a², b¹ and b² in the formulae (I), (IIa), (IIb) and (IV) will be given below.

X⁰ preferably comprises one or more connecting groups selected from the group consisting of —COO—, —OCO—, —O—, —CH₂COO— and —CH₂OCO—. V is preferably one connecting group selected from those exemplified above (with the proviso that Z¹ is a hydrogen atom). The symbols a¹, a², b³ and b² each are preferably a hydrogen atom or methyl group.

Specific examples of the group represented by (a¹)CH═C(a²)—V—W— in the formula (IV) will be given below, but the invention is not limited thereto. In the following examples, j represents an integer of from 1 to 12, k represents an integer of from 2 to 12, and the symbol a represents H or —CH₃.

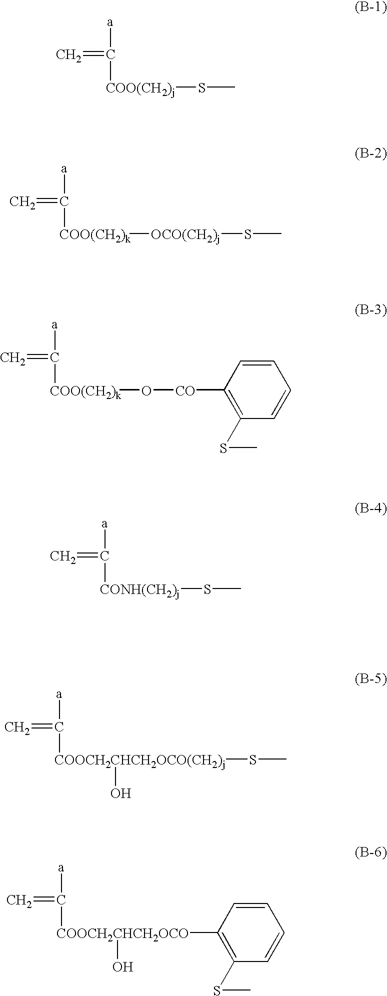

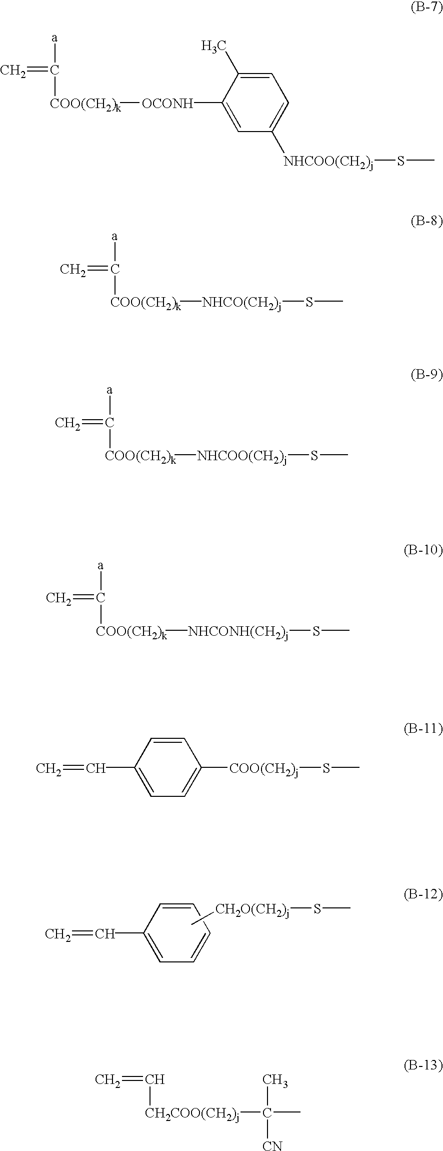

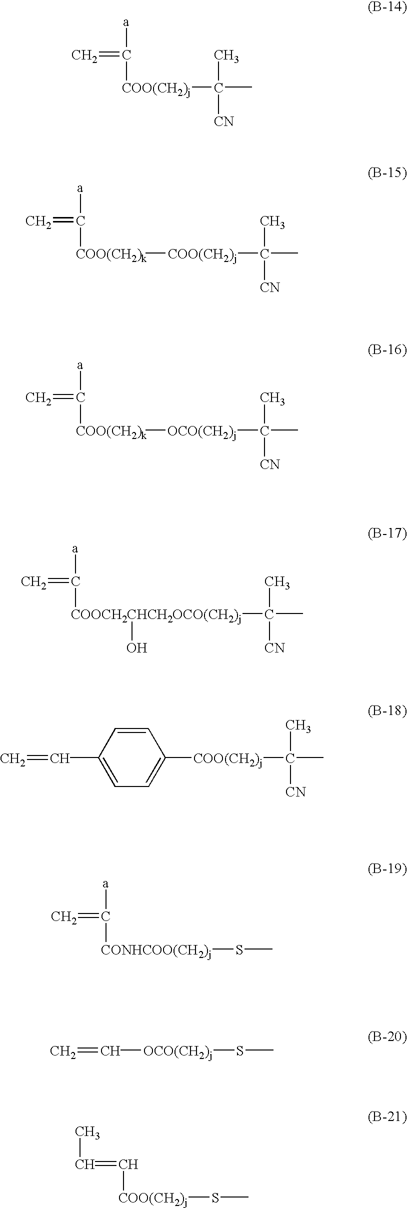

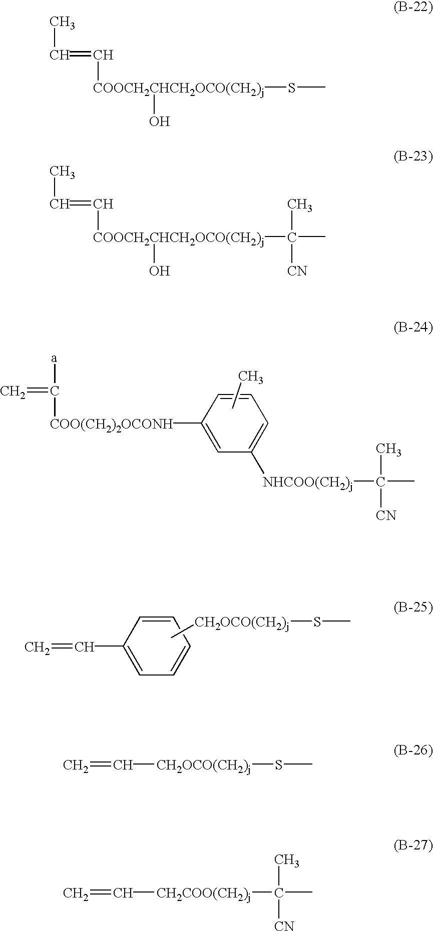

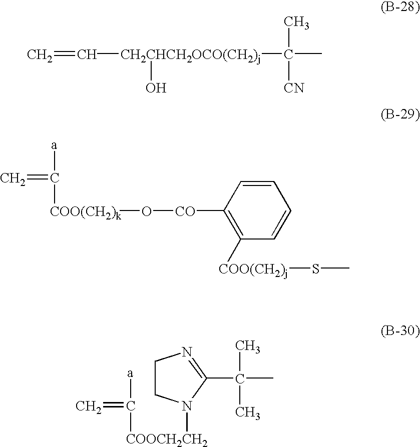

The macromonomer (M) of the invention can be produced by any known synthesis method. Examples of such a known synthesis method include (1) an ionic polymerization method which comprises reacting a living polymer obtained by anionic polymerization or cationic polymerization with various reagents at the end thereof to produce a macromonomer, (2) a radical polymerization method which comprises reacting a reactive group-terminated oligomer obtained by radical polymerization with various reagents in the presence of a polymerization initiator and/or chain transfer agent containing a reactive group such as carboxyl group, hydroxyl group and amino group in its molecule to produce a macromonomer, and (3) an addition polycondensation method which comprises incorporating a polymerizable double bond group in an oligomer obtained by polyaddition or polycondensation reaction in the same manner as in the aforementioned radical polymerization method.

For the details of these methods, reference can be made to general guidance and citations described in P. Dreyfuss & R. P. Quirk, “Encyclopedia Polymer Science Engineering”, vol. 7, page 551, 1987, P. F. Rempp & E. Franta, “Advanced Polymer Science”, vol. 58, page 1, 1984, V. Percec, “Applied Polymer Science”, vol. 285, page 95, 1984, R. Asami, M. Takagi, “Makramol. Chem. Suppl.”, vol. 12, page 163, 1985, P. Rempp, et al, “Makromol. Chem. Suppl.”, vol. 8, page 3, 1987, Yuusuke Kawakami, “Kagaku Kogyo (Chemical Industry)”, vol. 38, page 56, 1987, Tatsuya Yamashita, “Koubunshi (Polymer)”, vol. 31, page 988, 1982, Shirou Kobayashi, “Koubunshi (Polymer)”, vol. 30, page 625, 1981, Toshinobu Higashimura, “Journal of The Adhesion Society of Japan”, vol. 18, page 536, 1982, Kouichi Ito, “Koubunshi Kako (Polymer Processing)”, vol. 35, page 262, 1986, Shirou Touki & Takashi Tsuda, “Kinou Zairyou (Functional Materials)”, 1987, No. 10, 5, etc.

On the other hand, the monomer (S) constituting the main chain moiety soluble in the non-aqueous dispersion medium in the graft copolymer of the invention is preferably a monomer represented by the formula (III). The monomer represented by the formula (III) is a monomer which can be a copolymer component of the graft copolymer with the macro monomer (M).

In the formula (III), X1 has the same meaning as V in the formula (I) and preferably represents —COO—, —OCO—, —CH₂OCO—, —CH₂COO—, —O— or —Ph—. Q¹ represents a C₄-C₂₂ aliphatic group. Specific examples of the aliphatic group include those having four or more carbon atoms among the aliphatic groups represented by Z¹ in the formula (I).

The symbols c¹ and c² may be the same or different and have the same meaning as a¹ and a² in the formula (I), respectively. Preferably, any one of c¹ and c² represents a hydrogen atom.

Specific examples of the monomer represented by the formula (III) include polybutyl acrylate, polylauryl acrylate, polylauryl methacrylate, polystearyl acrylate, polystearyl methacrylate, poly-2-ethylhexyl methacrylate, and cetyl methacrylate.

The graft copolymer of the invention may further comprise other monojmers copolymerizable with the monomer represented by the formula (III) besides the monomer (III) as copolymer components. Examples of these monomers include acrylonitrile, methacrylonitrile, acrylamide, methacrylamide, hydroxyethyl methacrylate, dialkylaminoethyl methacrylate (e.g., dimethylaminoethyl methacrylate), dialkylaminomethylstyrene, heterocyclic compound containing polymerizable double bond group (e.g., vinylpyridine, vinylimidazoline, vinyl thiophene, vinyl dioxane, vinylpyrrolidone), unsaturated carboxylic acid (e.g., acrylic acid, methacrylic acid, itaconic acid, crotonic acid, maleic acid), itaconic anhydride, and maleic anhydride.

The monomer other than the monomer represented by the formula (III) is not limited so far as it is a copolymerizable monomer. Preferably, the proportion of the other monomers in the all polymer components of the graft copolymer is preferably not greater than 30% by weight.

Further, the graft copolymer of the invention may have at least one polar group selected from the group consisting of —PO₃H₂ group, —SO₂H group, —COOH group, —OH group, —SH group, —(Z⁰)P(O)OH group (in which Z⁰ represents —Z¹⁰ group or —OZ¹⁰ group wherein Z¹⁰ represents a hydrocarbon group), formyl group and amino group bonded thereto at one end thereof.

In the aforementioned group —(Z⁰)P(O)OH, Z⁰ represents —Z¹⁰ group or —OZ¹⁰ group wherein Z¹⁰ preferably represents a C₁-C₁₈ hydrocarbon group. Even more desirable examples of the hydrocarbon group represented by Z¹⁰ include C₁-C₈ aliphatic group which may be substituted (e.g., methyl group, ethyl group, propyl group, butyl group, pentyl group, hexyl group, butenyl group, pentenyl group, hexenyl group, 2-chloroethyl group, 2-cyanoethyl group, cyclopentyl group, cyclohexyl group, benzyl group, phenethyl group, chlorobenzyl group, bromobenzyl group), and aromatic group which may be substituted (e.g., phenyl group, tolyl group, xylyl group, mesityl group, chlorophenyl group, bromophenyl group, methoxyphenyl group, cyanophenyl group).

The amino group in the polar group of the invention represents —NH², —NH(Z¹¹) or —N(Z¹¹) (Z¹²). Z¹¹ and Z¹² each independently represent a C₁-C₁₈ hydrocarbon group, preferably C₁-C₈ hydrocarbon group. In some detail, Z¹¹ and Z¹² have the same meaning as the hydrocarbon group represented by Z¹. Even more desirable examples of the hydrocarbon groups represented by Z¹⁰, Z¹¹ and Z¹² include C₁-C₄ alkyl group which may be substituted, benzyl group which may be substituted, and phenyl group which may be substituted.

Referring to its chemical structure, the aforementioned polar group is connected to one end of the polymer main chain directly or via an arbitrary connecting group. The bond via which the graft copolymer component and the polar group are connected to each other is formed by an arbitrary combination of atomic groups such as carbon-carbon bond (single bond or double bond), carbon-heteroatom bond (Examples of heteroatom include oxygen atom, sulfur atom, nitrogen atom, and silicon atom) and heteroatom-heteroatom bond.

Preferred among the graft copolymers having a specific polar group connected to one end of the polymer main chain of the invention are those represented by the formulae (Va) and (Vb).

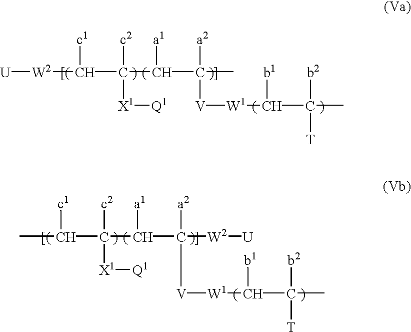

In the formulae (Va) and (Vb), a¹, a², b¹, b², c¹, c², X¹, Q¹, V, W¹ and T are as defined in the formulae (I) to (III). U represents the aforementioned polar group connected to one end of graft copolymer.

W² represents a single bond or a group which connects the specific group U to the polymer main chain. Specific examples of the group W² include those described with reference to W¹.

The graft copolymer has a specific polar group connected to the end of the polymer main chain as mentioned above is preferably free of copolymer component containing a polar group such as phosphono group, carboxyl group, sulfo group, hydroxyl group, formyl group, amino group, mercapto group and —Z⁰P(O)OH group in its polymer main chain.

The production of the graft copolymer having a specific polar group connected to one end of the polymer main chain can be easily accomplished by a synthesis method such as (1) a method (ionic polymerization method) which comprises reacting a living polymer obtained by conventional known anionic polymerization or cationic polymerization with various reagents at the end thereof, (2) a method (radical polymerization method) which comprises radical polymerization in the presence of a polymerization initiator and/or chain transfer agent containing a reactive group such as carboxyl group, hydroxyl group and amino group in its molecule and (3) a method which comprises subjecting a reactive group-terminated polymer obtained by the aforementioned polyaddition or polycondensation reaction to polymer reaction that causes the conversion to a specific polar group.

For the details of these methods, reference can be made to general guidance and citations described in P. Dreyfuss & R. P. Quirk, “Encyclopedia Polymer Science Engineering”, vol. 7, page 551, 1987, Yoshiki Nakajo & Masaya Yamashita, “Senryo to Yakuhin (Dye and Chemical)”, vol.30, page 232, 1985, Akira Ueda & Susumu Nagai, “Kagaku to Kogyo (Chemistry and Industry)”, vol. 60, page 57, 1986, etc.

Examples of the polymerization initiator containing a specific polar group in its molecule include azobis-based compounds such as 4,4′-azobis (4-cyanovaleric acid), 4,4′-azobis (4-cyanovaleric acid chloride), 2,2′-azobis(2-cyanopropanol), 2,2′-azobis(2-cyanopentanol), 2,2′-azobis[2-methyl-N-(2-hydroxyethyl) -propioamide], 2,2′-azobis{2-methyl-N-[1,1-bis(hydroxymethyl)ethylpropioamide], 2,2′-azobis{2-methyl-N-[1,1-bis(hydroxymethyl)-2-hydroxyethyl] propioamide}, 2,2′-azobis[2-(5-methyl-2-imidazole-2-il)propane], 2,2′-azobis[2-(4,5,6,7-tetrahydro-1H-1,3-diazepin-2-il)propane], 2,2′-azobis[2-(3,4,5,6-tetrahydropyrimidine-2-il)propane], 2,2′-azobis[2-(5-hydroxy-3,4,5,6-tetrapyrimidine-2-il)propane], 2,2′-azobis{2-[1-[2-hydroxyethyl]-2-imidazoline-2-il]propane}, 2,2′-azobis[N-(2-hydroxyethyl)-2-methyl-propionamidine] and 2,2′-azobis[N-(4-aminophenyl)-2-methylpropionamidine].

Examples of the chain transfer agent having a specific polar group incorporated in its molecule include mercapto compounds having the polar group or substituent which can be derived to the polar group (e.g., thioglycolic acid, thiomalic acid, thiosalicylic acid, 2-mercaptopropionic acid, 3-mercaptopropionic acid, 3-mercaptobutyric acid, N-(2-mercaptopropionyl)glycine, 2-mercaptonicotinic acid, 3-[N-(2-mercaptoethyl)carbamoyl]propionic acid, 3-[N-(2-mercaptoethyl)amino]propionic acid, N-(3-mercaptopropionyl)alanine, 2-mercaptoethanesulfonic acid, 3-mercaptosulfonic acid, 2-mercaptobutanesulfonic acid, 2-mercaptoethanol, 3-mercapto-1,2-propanediol, 1-mercapto-2-propanol, 3-mercapto-2-butanol, mercaptophenol, 2-mercaptoethylamine, 2-mercaptoimidazole, 2-mercapto-3-pyridinol), and alkyl iodide compounds having the aforementioned or substituent (e.g., iodoacetic acid, iodopropionic acid, 2-iodoethanol, 2-iodoethanesulfonic acid, 3-iodopropanesulfonic acid). Preferred among these compounds are mercapto compounds.

The chain transfer agent and polymerization initiator are each used in an amount of from 0.1 to 10 parts by weight, preferably from 0.5 to 5 parts by weight based on 100 parts by weight of all the monomers. The graft copolymer of the invention having a polar group connected to one end of the polymer main chain is preferably represented by the formula (Va) or (Vb). Specific examples of the site represented by U—W²-in these formulae include those described in JP-A-3-188463.

The graft copolymer has a number-average molecular weight of from 3,000 to 500,000, preferably from 10,000 to 200,000 as measured by GPC to advantage.

The ratio of components insoluble in the non-aqueous dispersion medium to components soluble in the non-aqueous dispersion medium of the graft copolymer is not specifically limited but is preferably such that the graft copolymer is substantially soluble in the non-aqueous dispersion medium. The term “substantially soluble” as used herein is meant to indicate that when a 5 wt-% solution of the graft copolymer is subjected to centrifugal separation at 15,000 rpm for 60 minutes, the resulting sedimentation content is not greater than 25% of the total weight of the solution.

The binder resin containing the graft copolymer may further comprise other resins such as polyester resin and wax incorporated therein for the purpose of improving the fix ability thereof.

The non-aqueous dispersion medium to be used in the oil-based composition for ink jet printer of the invention is a non-polar insulating solvent and preferably exhibits a dielectric constant of from 1.5 to 20 and a surface tension of from 15 to 60 mN/m (25° C.). More preferably, the non-aqueous dispersion medium is little poisonous, flammable and odorous.

The non-aqueous dispersion medium may be selected from the group consisting of straight-chain and branched aliphatic hydrocarbon, alicyclic hydrocarbon, aromatic hydrocarbon, petroleum naphtha and halogen substitution product thereof. For example, hexane, octane, isooctane, decane, isodecane, decalin, nonane, dodecane, isododecane, Isoper E, Isoper G, Isoper H and Isoper L (produced by Exxon Inc.), Solutol (produced by Phillips Petroleum Company), IP solvent (produced by Idemitsu Petrochemical Co., Ltd.), and petroleum naphtha (e.g., S. B. R. Shellsol 70, 71 (produced by Shell Petrochemical Co., Ltd.), Begasol (produced by Mobile Petroleum) may be used singly or in ad mixture.

Preferred examples of the hydrocarbon solvent employable herein include high purity isoparaffin-based hydrocarbons having a boiling point of from 150° C. to 350° C. Examples of commercially available hydrocarbon solvents include Isoper G, H, L, M and V (trade name) (produced by Exxon Chemical Inc.), Norva 12, 13, 15 (trade name), IP Solvent 1620, 2028 (trade name) (produced by Idemitsu Petrochemical Co., Ltd.), Isosol 300, 400 (trade name) (produced by Nippon Petrochemicals Co., Ltd.), and AMSCO OMS, AMSCO 460 solvent (produced by Spirit Co., Ltd.). These products are aliphatic saturated hydrocarbons having an extremely high purity and exhibit a viscosity of not greater than 3 cSt at 25° C., a surface tension of from 22.5 to 28.0 mN/m at 25° C. and a specific resistivity of not lower than 10¹⁰ Ω·cm at 25° C. These products have a low reactivity and hence a high stability, a low toxicity and hence a high safety, and little odor.

As the halogen-substituted hydrocarbon-based solvent there may be used a fluorocarbon-based solvent. Examples of such a fluorocarbon-based solvent include perfluoroalkanes represented by CₙF₂ₙ₊₂ such as C₇F₁₆ and C₈F₁₈ (“Florinert PF5080”, “Florinert PF5070”, produced by Sumitomo 3M), fluorine-based inert liquids (“Florinert FC Series”, produced by Sumitomo 3M), fluorocarbons (“Krytox GPL Series”, produced by Du Pont Kabushiki Kaisha), Frons (“HCFC-141b”, produced by DAIKIN INDUSTRIES, LTD.), and fluorocarbon iodides such as [F(CF₂)₄CH₂CH₂I] and [F(CF₂)₆I] (“I-1420”, “I-1600”, produced by Daikin Chemical Laboratory).

As the non-aqueous solvent to be used in the invention there may be also used a higher aliphatic ester or silicone oil. Specific examples of the silicone oil include low viscosity synthetic dimethylpolysiloxanes. Examples of commercially available silicone oils include KF96F (trade name) (produced by Shin-Etsu Chemical Co.,Ltd.), and SH200 (trade name) (produced by Dow Corning Toray Silicone Co., Ltd.).

The silicone oil is not limited to these specific examples. These dimethylpolysiloxanes are available having a very wide range of viscosity depending on their molecular weight but preferably have a viscosity of from 1 to 20 cSt. These dimethylpolysiloxanes have a volume resistivity of not lower than 10¹⁰ Ω·cm, a high stability, a high safety and odorlessness similarly to isoparaffinichydrocarbon. These dimethylpolysiloxanes have a low surface tension and a surface tension of from 18 to 21 mN/m.

Examples of solvents which can be used in admixture with these organic solvents include alcohols (e. g. , methyl alcohol, ethyl alcohol, propyl alcohol, butyl alcohol, fluorinated alcohol), ketones (e. g., acetone, methyl ethyl ketone, cyclohexanone), carboxylic acid esters (e.g., methyl acetate, ethyl acetate, propyl acetate, butyl acetate, methyl propionate, ethyl propionate), ethers (e.g., diethyl ether, dipropyl ether, tetrahydrofurane, dioxane), and halogenated hydrocarbons (e.g., methylene dichloride, chloroform, carbon tetrachloride, dichloromethane, methyl chloroform).

The coloring material to be used in the invention will be further described hereinafter.

The coloring material to be used herein is not specifically limited and may be any commercially available organic or inorganic pigment.

Examples of the coloring material which assumes yellow include monoazo pigments such as C. I. pigment yellow 1 (Fast Yellow G) and C. I. Pigment Yellow 74, disazo pigments such as C. I. Pigment Yellow 12 (Disazo Yellow AAA) and C. I. Pigment Yellow 17, non-benzidine-based azo pigments such as C. I. Pigment Yellow 180, azo lake pigments such as C. I. Pigment Yellow 100 (e.g., Tartrazine Yellow), condensed azo pigments such as C. I. Pigment Yellow 95 (e. g., condensed azo yellow GR), acidic dye lake pigments such as C. I. Pigment Yellow 115 (e.g., quinoline yellow lake), basic dye lake pigments such as C. I. Pigment Yellow 18 (e.g., thioflavine lake), anthraquinone-based pigments such as Flavanthrone (Y-24), isoindolinone pigments such as Isoindolinone Yellow 3RLT (Y-110), quinophthalone pigments such as Quinophthalone Yellow (Y-138), isoindoline pigments such as Isoindoline Yellow (Y-139), nitroso pigments such as C. I. Pigment Yellow 153 (e.g., nickel nitroso yellow), and metal complex azomethine pigments such as C. I. Pigment Yellow 117 (e.g., copper azomethine yellow).

Examples of the coloring material which assumes magenta include monoazo-based pigments such as C. I. Pigment Red 3 (e.g., toluidine red), disazo pigments such as C. I. Pigment Red 38 (e.g., pyrazolone B), azo lake pigments such as C. I. Pigment Red 53:1 (e.g., lake red C) and C. I. Pigment Red 57:1 (e.g., brilliant carmine 6B), condensed azo pigments such as C. I. Pigment Red 174 (e.g., phloxine B lake), basic dye lake pigments such as C. I. Pigment Red 81 (e.g., rhodamine 6G′ lake), anthraquinone-based pigments such as C. I. Pigment Red 177 (e.g., dianthraquinonyl red), thioindigo pigments such as C. I. Pigment Red 88 (e.g., thioindigo bordeaux), perinone pigments such as C. I. Pigment Red 194 (e.g., perinone red), perylene pigments such as C. I. Pigment Red 149 (e.g., perylene scarlet), quinacridone pigments such as C. I. pigment red 122 (e.g., quinacridone magenta), isoindolinone pigments such as C. I. Pigment Red 180 (e.g., isoindolinone red 2BLT), and alizarin lake pigments such as C. I. Pigment Red 83 (e.g., mada lake).

Examples of the coloring material which assumes cyan include disazo-basedpigments such as C. I. Pigment Blue 25 (e.g., dianisidine blue), phthalocyanine pigments such as C. I. Pigment Blue 15 (e. g., phthalocyanine blue), acidic dye lake pigments such as C. I. Pigment Blue 24 (e.g., peacock blue lake), basic dye lake pigments such as C. I. Pigment Blue 1 (e.g., biclothia pure blue BO lake), anthraquinone-based pigments such as C. I. Pigment Blue 60 (e.g., indanthrone blue), and alkaline blue pigments such as C. I. Pigment Blue 18 (e.g., alkali blue V-5:1).

Examples of the pigment which assumes black include organic pigments such as aniline black-based pigment (e. g., BK-1 (aniline)), iron oxide pigments, and carbon black pigments such as furnace black, lamp black, acetylene black and channel black.

Specific examples of the carbon black pigment include MA-8, MA-10, MA-11, MA-100, MA-200, #25, #40, #260, #2600, #2700B, #3230B CF-9 and MA-200RB (produced by MITSUBISHI CHEMICAL CORPORATION), Printex 75 and 90 (produced by Degussa Inc.), and Monark 800 and 1100 (produced by Cabot Co., Ltd.). Metal powders may be applied for color reproduction of gold, silver, copper, etc.

The coloring material of the invention is preferably subjected to surface treatment as described in “Ganryou Bunsan Gijutsu (Pigment Dispersion Technology)”, Technical Information Institute, vol. 5 to facilitate atomization and enhance dispersibility. Examples of the surface treatment of coloring material include rosin treatment and flushing resin treatment. Further, commercially available processed pigments may be used as coloring materials. Specific examples of the commercially available processed pigments include microlith pigments produced by Ciba Speciality Chemicals Co., Ltd.

Referring to the amount of the pigment and the binder resin, the binder resin is used in an amount of from 0.3 to 10 parts by weight, preferably from 0.4 to 7 parts by weight, more preferably from 0.5 to 5 parts by weight based on 1 part by weight of the pigment. When the amount of the binder resin falls below 0.3 parts by weight based on the weight of the pigment, the resulting effect of dispersing pigment during kneading is reduced to disadvantage. On the contrary, when the amount of the binder resin exceeds 10 parts by weight based on the weight of the pigment, the resulting ink composition exhibits a lowered pigment concentration and hence gives a reduced image density, making it impossible to obtain a required image density.

The step of coating the coloring material with the binder resin formed by the graft copolymer to prepare a colored mixture will be described hereinafter. The colored mixture is prepared, e.g., by any of the following methods.

(1) Method which comprises melt-kneading a coloring material and a binder resin at a temperature of not lower than the melting point of the binder resin using a kneading machine such as roll mill, Banbury mixer and kneader, cooling the mixture, and then grinding the mixture to obtain a colored mixture;

(2) Method which comprises dissolving a binder resin in a solvent, adding a coloring material to the solution, subjecting the mixture to wet dispersion using a ball mill, attritor, sand grinder or the like, and then allowing the solvent to evaporate to obtain a colored mixture or pouring the dispersion into a non-solvent for the binder resin to cause the precipitation of a mixture which is then dried to obtain a colored mixture; and

(3) Method which comprises subjecting a hydrous paste (wet cake) of pigment to flushing process so that it is kneaded with a resin or resin solution, replacing water by the resin or resin solution, and then evaporating water and the solvent under reduced pressure to obtain a colored mixture.

The dispersion step of finely dispersing the aforementioned colored mixture in the non-aqueous dispersion medium will be described hereinafter.

At the dispersion step, a pigment dispersant is preferably used to cause the colored mixture to be finely dispersed in the non-aqueous dispersion medium and stabilize the dispersion.

As the pigment dispersant of the invention for finely dispersing the coloring material in the non-aqueous dispersion medium there may be used an ordinary pigment dispersant which can be used in the non-aqueous dispersion medium. Any pigment dispersant may be used so far as it is compatible with the non-polar insulating solvent and can cause fine dispersion of pigment. Specific examples of the pigment dispersant include nonionic surface active agents such as sorbitanaliphatic acid ester (e.g., sorbitan monooleate, sorbitan monolaurate, sorbitan sesquioleate, sorbitan trioleate), polyoxyethylenesorbitanaliphatic acid ester (e.g., polyoxyethylenesorbitan monostearate, polyoxyethylenesorbitan monooleate), polyethyleneglycolaliphatic acid ester (e.g., polyoxyethylene monostearate, polyethylene glycol diisostearate), polyoxyethylenealkylphenyl ether (e. g. , polyoxyethylenenonyl phenyl ether, polyxoyethylene octyl phenyl ether) and aliphatic diethanol amide-based compound, and polymer-based dispersants such as polymer compound having a molecular weight of not smaller than 1,000. Examples of the polymer compound include styrene-maleic acid resin, styrene-acrylicresin, rosin, BYK-160, 162, 164, 182 (urethane-based polymer compounds produced by Byk-Chemie Japan Co., Ltd.), EFKA-47 and LP-4050 (urethane-based dispersants produced by EFKA), Sorsperse 24000 (polyester-based polymer compound produced by Zeneca Co., Ltd.), and Sorsperse 17000 (aliphatic diethanolamide-based compound produced by Zeneca Co., Ltd.).

Further examples of the polymer-based pigment dispersant include monomers which can be solvated to the dispersing medium such as lauryl methacrylate, stearyl methacrylate, 2-ethylhexyl methacrylate and cetylmethacrylate, monomers which canbe difficultly solvated to the dispersing medium such as methyl methacrylate, ethyl methacrylate, isopropyl methacrylate, styrene and vinyl toluene, random copolymers comprising a moiety having a polar group, and graft copolymers disclosed in JP-A-3-188469. In the case where such a graft copolymer is used, the same graft copolymer as used as binder resin may be used as a pigment dispersant.

Examples of the monomer containing a polar group include acidic group monomers such as acrylic acid, methacrylic acid, itaconic acid, fumaric acid, maleic acid, styrenesulfonic acid and alkaline salt thereof, and basic group monomers such as dimethylaminoethyl methacrylate, diethylaminoethyl methacrylate, vinyl pyridine, vinyl pyrrolidine, vinyl piperidine and vinyl lactam. Other examples of the monomer containing a polar group include styrene-butadiene copolymer, and block copolymer of styrene and long-chain alkyl methacrylate disclosed in JP-A-60-10263. Preferred examples of the monomer containing a polar group include graft copolymers disclosed in JP-A-3-188469.

The amount of the pigment dispersant to be used is preferably from 0.1 to 300 parts by weight based on 100 parts by weight of the pigment. When the amount of the pigment dispersant to be incorporated falls below 0.1 parts by weight, the resulting effect of dispersing pigment is reduced to disadvantage. On the contrary, even when the amount of the pigment dispersant to be incorporated exceeds 300 parts by weight, the expected effect cannot be obtained.

Examples of the method for using the colored mixture and the pigment dispersant will be given below.

1. Method which comprises adding a pigment composition having a colored mixture and a pigment dispersant incorporated therein to a non-aqueous dispersion medium to cause dispersion;

2. Method which comprises separately adding a colored mixture and a pigment dispersant to a non-aqueous dispersion medium to cause dispersion;

3. Method which comprises mixing a non-aqueous dispersion medium with a dispersion obtained by separately dispersing a colored mixture and a pigment dispersant (The pigment dispersant may be dispersed in a solvent alone);

4. Method which comprises dispersing a colored mixture in a non-aqueous dispersion medium, and then adding a pigment dispersant to the resulting pigment dispersion.

Any of these methods can provide the desired effect.

As the machine for mixing or dispersing the aforementioned colored mixture with the non-aqueous dispersion medium there may be used a disolver, high speed mixer, homomixer, kneader, ball mill, roll mill, sand mill, attritor or the like. The average particle diameter of the colored mixture thus dispersed at the dispersion step is from 0.01 to 10 μm, preferably from 0.01 to 1.0 μm.

The oil-based composition for ink jet printer of the invention can be used as an oil-based ink in various ink jet recording processes. Examples of the ink jet recording process to which the invention can be applied include piezo process, electrostatic ink jet printer such as slit jet of Toshiba, NTT, etc., and thermal process ink jet printer.

Further, the ink composition of the invention is suitable for use as electrophotographic liquid developer.

### EXAMPLES

Examples of the graft copolymer of the invention and examples of the production thereof will be given, but the invention is not limited thereto.

### Macro monomer Production Example 1: (M-1)

Amixture of 100 g of methyl methacrylate, 4.5 g of thioglycolic acid and 200 g of toluene was heated to a temperature of 75° C. with stirring in a stream of nitrogen. To the solution was then added 2.0 g of 2,2′-azobisisobutyronitrile (hereinafter abbreviated to “A. I. B. N.”). The reaction mixture was then reacted for 4 hours. The reaction solution was then cooled to room temperature. To the reaction solution were then added 9.0 g of glycidyl methacrylate, 0.1 g of hydroquinone and 3.6 g of tetrabutylammonium bromide. The reaction mixture was then reacted at a temperature of 90° C for 5 hours.

The reaction solution was cooled, and then subjected to reprecipitation in 2 l of methanol. The while solid matter thus precipitated was collected by decantation, dissolved in 300 ml of tetrahydrofuran, and then subjected to reprecipitation in 3 l of methanol. The white powder thus precipitated was collected, and then dried under reduced pressure to a macro monomer (M-1) having a weight-average molecular weight of 15,500 in a yield of 94.0 g. The molecular weight of the macro monomer was represented in polystyrene equivalence as determined by GPC.

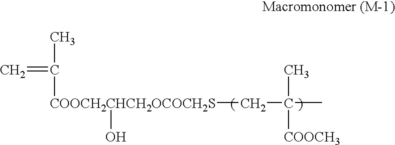

### Macro monomer Production Example 2: (M-2)

Amixture of 100 g of methyl methacrylate, 4.5 g of thioglycolic acid and 200 g of toluene was heated to a temperature of 70° C. with stirring in a stream of nitrogen. To the solution was then added 1.0 g of A. I. B. N.. The reaction mixture was then reacted for 2 hours. To the reaction solution was then added 0.5 g of A. I. B. N. The reaction mixture was then reacted for 3 hours. The reaction solution was then cooled to room temperature. To the reaction solution were then added 8.3 g of 2-hydroxyethyl methacrylate. To the reaction mixture was then added dropwise a mixture of 13.3 g of dicyclohexyl carbodiimide (abbreviated to “D. C. D.”) and 20 g of methylene chloride in 1 hour. To the reaction mixture were then added 0.1 g of 4-dimethylaminopyridine and 0.1 g of t-butylhydroquinone. The reaction mixture was then stirred for 4 hours.

The resulting crystal was then withdrawn by filtration. The resulting filtrate was then subjected to reprecipitation in 2 l of methanol. The while solid matter thus precipitated was collected by decantation, dissolved in 300 ml of tetrahydrofuran, and then subjected to reprecipitation in 3 l of methanol. The white powder thus precipitated was collected, and then dried under reduced pressure to a macromonomer (M-2) having a weight-average molecular weight of 15,500 in a yield of 93.2 g. The molecular weight of the macromonomer was represented in polystyrene equivalence as determined by GPC.

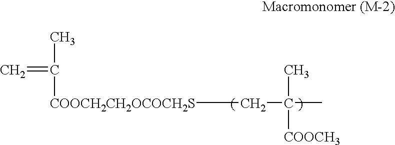

### Macromonomer Production Examples 3-10: (M-3) to (M-10)

Macromonomers (M-3) to (M-10) set forth in Table A below were prepared in the same manner as in Macromonomer Production Example 1 except that methacrylate monomer (corresponding to methyl methacrylate), the chain transfer agent (corresponding to thioglycolic acid), the initiator (corresponding to A. I. B. N.) and unsaturated carboxylic acid ester (corresponding to glycidyl methacrylate and 2-hydroxyethyl methacrylate) to be used in Macromonomer Production Examples 1 and 2 were replaced by the respective corresponding compounds. The weight-average molecular weight of the various macromonomers thus obtained was from 4,600 to 61,000.

TABLE A

| Macromonomer | | |
|---|---|---|
| production | | |
| example | Macromonomer | Chemical structure of macromonomer |
| 3 | M-3 | 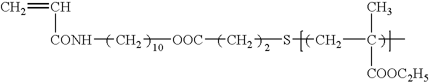 |
| 4 | M-4 | 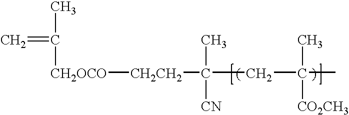 |
| 5 | M-5 | 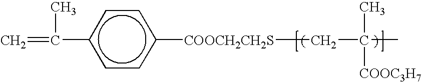 |
| 6 | M-6 | 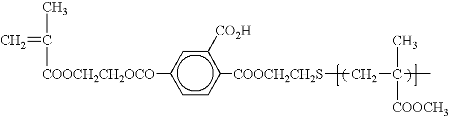 |
| 7 | M-7 | 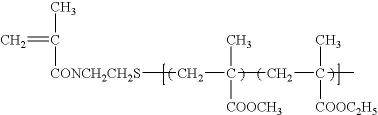 |
| 8 | M-8 | 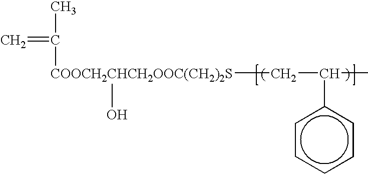 |
| 9 | M-9 | 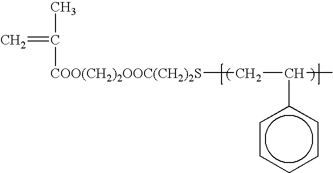 |
| 10 | M-10 | 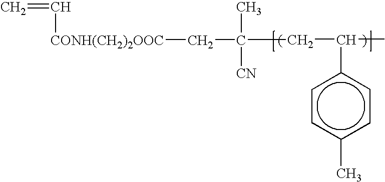 |

### Binder Resin Production Example 1: (P-1)

A styrene-based macromonomer (terminal group: methacryloyl group; number-average molecular weight: 6,000) available as AS-6 from TOAGOSEI CO., LTD. was used to synthesize a graft copolymer. In same detail, a mixture of 20 g of the styrene-based macro monomer (AS-6), 80 g of 2-ethylhexyl methacrylate and 200 g of toluene was measured out in a four-necked flask. The mixture was then heated to a temperature of 80° C. with stirring in a stream of nitrogen.

As a polymerization initiator, 1 g of 1,1′-azobis(l-cyclohexanecarbonitrile) was added. The reaction mixture was subjected to polymerization at a temperature of 80° C. for 24 hours. After polymerization, the reaction solution was cooled to room temperature. To the reaction solution was then added 200 g of toluene. The reaction mixture was then subjected to reprecipitation in 4 l of methanol. The resulting solution was then filtered. The resulting white powder was then dried to obtain 92 g of a graft copolymer [P(2-ethylhexyl methacrylate) -g-P(styrene)] powder having a weight-average molecular weight of 7.9×10⁴. This binder resin was soluble (5% by weight) in Isoper G.

### Binder Resin Production Examples 2-14: (P-2) to (P-14)

Various binder resins were prepared in the same manner as in Binder Resin Production Example 1 except that the styrene-based macromonomer (AS-6) and 2-ethylhexyl methacrylate were replaced by the macromonomers and monomers set forth in Table B, respectively. The various binder resins each had a weight-average molecular weight of from 1.1×10⁴ to 1.4×10⁵.

The various binder resins were soluble in a 5 wt-% Isoper G solution. Alternatively, the sedimentation content developed when the Isoper G solution is subjected to centrifugal separation at 15,000 rpm for 60 minutes was not greater than 20%, demonstrating that the binder resins are substantially soluble.

In Table B, AA-6 and AA-2 are methyl methacrylate-based macromonomers ternminated by a methacryloyl group having a number-average molecular weight of 6,000 and 2,000, respectively, available from TOAGOSEI CO., LTD.

TABLE B

| Binder resin | | | Monomer/ |
|---|---|---|---|
| production | | | macromonomer |
| example | Monomer | Macromonomer | (wt/wt) |
| P-2 | SMA | AS-6 | 80/20 |
| P-3 | LMA | AS-6 | 70/30 |
| P-4 | 2EHMA | AS-6 | 70/30 |
| P-5 | SMA | AA-6 | 70/30 |
| P-6 | SMA | AA-6 | 90/10 |
| P-7 | 2EHMA | AA-6 | 90/10 |
| P-8 | LMA | AA-6 | 70/30 |
| P-9 | SMA | AA-2 | 90/10 |
| P-10 | 2EHMA | AA-2 | 80/20 |
| P-11 | SMA | M-2 | 80/20 |
| P-12 | 2EHMA | M-2 | 80/20 |
| P-13 | 2EHMA | M-9 | 80/20 |
| P-14 | LMA | M-9 | 90/10 |

* SMA: Stearyl methacrylate
LMA: Lauryl methacrylate
2EHMA: 2-Ethylhexyl methacrylate

### Comparative Binder Resin Production Example 1: (R-1)

90 g of methyl methacrylate, 10 g of stearyl methacrylate and 200 g of toluene were measured out in a four-necked flask as in Binder Resin Production Example 1. The reaction mixture was heated to a temperature of 75° C. in a stream of nitrogen gas for 1 hour. To the reaction mixture was then added 2 g of 1,1′-azobis(1-cyclohexanecarbonitrile) as a polymerization initiator. The reaction mixture was then reacted at a temperature of 80° C. for 8 hours. The reaction mixture was then subjected to reprecipitation in methanol as in Production Example 1 to obtain a polymer (R-1). The polymer thus obtained was a random copolymer having a weight-average molecular weight of 2.7×10⁴.

### Comparative Binder Resin Production Example 2: (R-2)

A comparative binder resin (R-2) which is a random copolymer was synthesized in the same manner as in Comparative Binder Resin Production Example 1 except that 10 g of stearyl methacrylate was replaced by 30 g of butyl methacrylate and the amount of methyl methacrylate was changed to 70 g. The comparative binder resin (R-2) had a weight-average molecular weight of 3.4×10⁴.

### Example 1

<Production of Ink Composition (IJ-1)>

100 parts by weight of Hostaperm Blue B2G (produced by Clariant Japan K.K.) as a blue pigment and 100 parts by weight of the aforementioned resin (P-1) as a binder resin were previously ground using a trioblender, and then subjected to melt kneading in a three-roll mill which had been heated to a temperature of 90° C. (120 minutes). The pigment blend thus obtained was then ground using a pin mill.

Subsequently, 25 parts by weight of a 20 wt-% solution prepared by dissolving 10 parts by weight of the pigment blend, 65 parts by weight of Isoper G65and a pigment dispersant (D-1) having the following structure in Isoper G on heating were mixed with 250 parts of 3G-X glass beads in a paint shaker (produced by Toyo Seiki K.K.) for 120 minutes. The particulate pigment resin in the dispersion was then measured for volume-average particle diameter by means of a Type CAPA700 ultracentrifugal automatic particle size distribution measuring instrument (produced by HORIBA, LTD.). As a result, it was found that the volume-average particle diameter of the particulate resin was 0.25 μm, demonstrating that the resin particles were fairly dispersed in the solution.

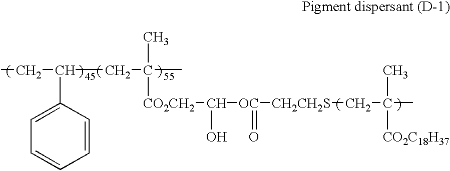

(The copolymerization ratio is represented by molar ratio)

The pigment resin particle dispersion obtained by removing the glass beads by filtration was concentrated by distilling the solvent off the dispersion, and then diluted with Isoper G to prepare an ink composition (IJ-1). The ink composition thus obtained had a pigment resin particle concentration of 18% by weight, a viscosity of 11 cp (as measured at a temperature of 25° C. by a Type E viscometer) and a surface tension of 23 mN/m (as measured at a temperature of 25° C. by an automatic surface tensiometer produced by Kyowa Interface Science Co., LTD).

<Ink Jet Recording>

As an ink jet recording device there was used a Type Saiyuki UX-E1CL color facsimile (produced by SHARP CORPORATION) which was then loaded with the ink composition (IJ-1). Under these conditions, an image was drawn on a high grade film ink jet paper produced by Fuji Photo Film Co., Ltd. As a result, the ink was ejected stably without nozzle clogging. The image thus drawn had no running and an image density of 1.5 and thus was definite. Subsequently, a fully-solid pattern was printed on the paper. The printed matter was then dried. The solid area was then rubbed with finger. As a result, the image was visually observed having no background stain, demonstrating that the ink composition exhibits an extremely excellent scratch resistance. The ink composition (IJ-1) underwent no sedimentation and agglomeration even after prolonged storage, demonstrating that it exhibits an extremely good dispersibility.

### Comparative Examples 1 to 4

The melt kneading procedure of Example 1 was followed except that the binder resin (P-1) of the invention was replaced by the comparative binder resin (R-1), the comparative binder resin (R-2) and the polyester resin GV-230 (produced by Toyobo Co., Ltd.), which are random copolymers. Thus, pigment blends of Comparative Examples 1 to 3 were obtained.

In Comparative Example 4, as a pigment blend there was used Hostacopy C601 (produced by Clariant Japan K.K.), which is a polyester master batch.

The pigment blends thus obtained were each processed in the same manner as in Example 1 to prepare comparative ink compositions (S-1) to (S-4). These ink compositions each had a surface tension of 23mN/m. The viscosity of these ink compositions were each adjusted to a range of from 10 to 14 cp by changing the pigment resin particle concentration thereof. The results of evaluation of properties of the comparative ink compositions S- to S-4 are set forth in Table C.

TABLE C

| | | Particle | | | | |
|---|---|---|---|---|---|---|
| | | diameter of | Dispersion | | | |
| | | particulate | stability of | Ejection | | Scratch |
| | Ink | pigment resin | ink | stability | | resistance |
| Example No. | composition | (μm) | composition | (clogging) | Image quality | of image |
| Example 1 | IJ-1 | 0.25 | Excellent | Excellent | Good | Excellent |
| | | | | (no clogging) | | |
| Comparative | S-1 | 0.88 | Fair/poor | Poor | Poor (white | Poor (dropped |
| Example 1 | | | (agglomerate | (clogged) | streak | by rubbing |
| | | | produced) | | occurred) | with finger) |
| Comparative | S-2 | 1.36 | Poor | Poor | Poor (white | Poor (dropped |
| Example 2 | | | (agglomerate | (clogged) | streak | by rubbing |
| | | | produced) | | occurred) | with finger) |
| Comparative | S-3 | 1.32 | Poor | Poor | Poor (white | Poor (dropped |
| Example 3 | | | (agglomerate | (clogged) | streak | by rubbing |
| | | produced) | | occurred) | with finger) | |
| Comparative | S-4 | 1.39 | Poor | Poor | Poor (white | Poor (dropped |
| Example 4 | | | (agglomerate | (clogged) | streak | by rubbing |
| | | | produced) | occurred) | with finger) | |

As can be seen in Table C, the ink composition (IJ-1) comprising the binder resin (P-1) of the invention has a particulate pigment resin finely dispersed and shows no sedimentation and agglomeration even after prolonged storage, demonstrating that it exhibits an excellent dispersion stability. On the other hand, the ink compositions (S-1) to (S-4) of Comparative Examples 1 to 4 had coarse pigment resin particles incorporated there in and underwent remarkable agglomeration even after a short storage.

Referring to ejection stability, the ink composition (IJ-1) of the invention caused no nozzle clogging while all the comparative ink compositions (S-1) to (S-4) showed instability in ejection after consecutive one hour and caused nozzle clogging.

Referring to the quality of image drawn by the ink jet recording device, the ink composition (IJ-1) of the invention showed running and gave a good and sharp image while the comparative ink compositions (S-1) to (S-4) showed malejection from the beginning of drawing and thus caused white streak which is a partial drop of image. Referring to the scratch resistance of image drawn, the ink composition (I-1) of the invention showed no background stain and hence an excellent scratch resistance while all the comparative ink compositions (S-1) to (S-4) gave an image which is subject to drop by rubbing with finger on solid image area.

As mentioned above, the ink composition comprising the binder resin (P-1) of the invention has pigment resin particles finely dispersed therein and thus shows an excellent dispersion stability, causes no nozzle clogging and thus shows an excellent ejection stability, causes no running and thus gives a good and sharp image having an excellent scratch resistance.

### Ink Composition Example 2

<Production of Ink Composition (IJ-2)>

100 parts by weight of Toner Yellow HG (PY180, produced by Clariant Japan K.K.) as a yellow pigment and 100 parts by weight of the aforementioned resin (P-4) as a binder resin were previously ground using a trioblender, and then subjected to melt kneading in a Type PBV bench kneader (produced by Irie Shokai K.K.) which had been heated to a temperature of 100° C. (120 minutes). The pigment blend thus obtained was then ground using a pin mill.

Subsequently, 90 parts by weight of a 20 wt-% Isoper G solution of 18 parts by weight of the pigment blend, 16 parts by weight of Isoper G16 and the pigment dispersant (D-1) as used in Example 1 were mixed with 250 parts of MK-3GX glass beads in a paint shaker (produced by Toyo Seiki K.K.) for 30 minutes, and then subjected to wet dispersion at 3,000 rpm using a Type KDL dynomill (produced by Sinmaru Enterprise Co., Ltd.) for two hours. The particulate pigment resin in the dispersion had a volume-average particle diameter of 0.26 μm, demonstrating that the resin particles were fairly dispersed in the solution.

The particulate pigment resin thus obtained was then processed in the same manner as in Example 1 to prepare an ink composition (IJ-2). The ink composition thus obtained showed a surface tension of 23 mN/m. The viscosity of the ink composition was adjusted to 12 cp by changing the pigment resin particle concentration thereof.

The ink composition thus obtained was then evaluated for image quality in the same manner as in Example 1. As a result, the ink composition was stably ejected over an extended period of time without nozzle clogging. The image thus drawn showed no running and a density of 1.2 and thus was definite. The image thus drawn was also excellent in scratch resistance on the solid image area. The ink composition thus obtained showed no sedimentation and agglomeration even after prolonged storage and hence an extremely good dispersibility.

### Examples 3 to 8

<Production of Ink Compositions (IJ-3) to (IJ-8)>

The procedure of melt kneading and wet dispersion of Example 2 was followed except that the binder resin (P-4) was replaced by the various binder resins set forth in Table D, respectively. Thus, ink compositions (IJ-3) to (IJ-8) were obtained. The melt kneading temperature was predetermined to a range of from 80° C. to 150° C., which is higher than the softening point of the binder resin. The various ink compositions each had a surface tension of 23 mN/m. The viscosity of these ink compositions were each adjusted to a range of from 10 to 14 cp by changing the pigment resin particle concentration thereof.

The results of the volume-average particle diameter of pigment resin particles in the dispersion of the ink compositions (IJ-3) to (IJ-8) are set forth in Table D.

TABLE D

| | | Volume-average |
|---|---|---|
| Ink | Binder | particle diameter |
| composition | resin | (μm) |
| IJ-3 | P-5 | 0.29 |
| IJ-4 | P-2 | 0.26 |
| IJ-5 | P-10 | 0.25 |
| IJ-6 | P-11 | 0.24 |
| IJ-7 | P-12 | 0.25 |
| IJ-8 | P-13 | 0.27 |

The ink compositions (IJ-3) to (IJ-8) were each then evaluated for image quality in the same manner as in Example 2. All the ink compositions were stably ejected without nozzle clogging over an extended period of time and gave a definite image free of running and having a sufficient density and a good quality. It was also found that the image thus drawn is excellent in scratch resistance on the solid image area. The ink compositions (IJ-3) to (IJ-8) showed no sedimentation and agglomeration even after prolonged storage and hence an extremely good dispersibility.

### Examples 9 to 13

<Production of Ink Compositions (IJ-9) to (IJ-13)>

Ink compositions (IJ-9) to (IJ-13) were obtained in the same manner as in Example 2 except that Toner Yellow HG (PY180, produced by Clariant Japan Co., Ltd.) as a yellow pigment was replaced by red, black and blue pigments set forth in Table E, respectively. The surface tension and viscosity of the ink compositions (IJ-9) to (IJ-13) were adjusted to 23 mN/m and 12, respectively.

The results of the volume-average particle diameter of pigment resin particles in the dispersion of the ink compositions (IJ-9) to (IJ-13) are set forth in Table E.

TABLE E

| | | Volume-average |
|---|---|---|
| Ink | Color | particle diameter |
| composition | pigment | (μm) |
| IJ-9 | Linol blue FG-7350 *1 | 0.22 |
| IJ-10 | Toner magenta E02 *2 | 0.23 |
| IJ-11 | Toner magenta EB *2 | 0.25 |
| IJ-12 | Carbon black MA-8 *3 | 0.25 |
| IJ-13 | Hostaperm blue B2G *4 | 0.22 |

*1: Pigment Blue 15:3 (produced by TOYO INK MFG. CO., LTD.)
*2: Pigment Bed 122 (produced by Clariant Japan Co., Ltd.)
*3: Pigment Black 7 (produced by MITSUBISHI CHEMICAL CORPORATION)
*4: Pigment Blue 15:3 (produced by Clariant Japan Co., Ltd.)

The ink compositions (IJ-9) to (IJ-13) were each then evaluated for image quality in the same manner as in Example 1. All the ink compositions were stably ejected without nozzle clogging over an extended period of time and gave a definite image free of running and having a sufficient density and a good quality. It was also found that the image thus drawn is excellent in scratch resistance on the solid image area. The ink compositions (IJ-9) to (IJ-13) showed no sedimentation and agglomeration even after prolonged storage and hence an extremely good dispersibility.

### Examples 14 to 17

<Production of Ink Compositions (IJ-14) to (IJ-17)>

The procedure of wet dispersion of Example 1 was followed except that the pigment dispersant (D-1) was replaced by Solsperse 17000 (pigment dispersant commercially available from Avecia K.K.). The pigment resin particle dispersion thus obtained had a volume-average particle diameter of 0.24 μm. The surface tension and viscosity of the pigment resin particle dispersion were then properly adjusted to obtain an ink composition (IJ-14).

Subsequently, the surface tension and viscosity of the ink composition were adjusted in the same manner as in the production of the ink composition (IJ-14) except that the red and black pigments set forth in Table F were used in an amount of 50% based on Solsperse 17000. Thus, ink compositions (IJ-15) to (IJ-17) were obtained. The results of the volume-average particle diameter of pigment resin particles in the dispersion of the ink compositions (IJ-15) to (IJ-17) are set forth in Table F.

TABLE F

| | | Volume-average |
|---|---|---|
| Ink | Color | particle diameter |
| composition | pigment | (μm) |
| IJ-15 | Carbon black MA-8 | 0.22 |
| IJ-16 | Toner magenta E02 | 0.20 |
| IJ-17 | Toner magenta EB | 0.21 |

The ink compositions (IJ-14) to (IJ-17) were each then evaluated for image quality in the same manner as in Example 1. All the ink compositions were stably ejected without nozzle clogging over an extended period of time and gave a definite image free of running and having a sufficient density and a good quality. It was also found that the image thus drawn is excellent in scratch resistance on the solid image area. The ink compositions (IJ-14) to (IJ-17) showed no sedimentation and agglomeration even after prolonged storage and hence an extremely good dispersibility.

### Examples 18 to 21

<Production of Ink Compositions (IJ-18) to (IJ-21)>

Ink compositions (IJ-18) to (IJ-21) were obtained by adjusting the surface tension and viscosity of ink composition in the same manner as in the production of the ink composition (IJ-1) of Example 1 except that the pigment dispersant (D-1) was replaced by the aforementioned binder resins (P-5) and (P-7), which are graft copolymers, and pigment dispersants (D-2) and (D-3) having the following structures as set forth in Table G. The results of the volume-average particle diameter of pigment resin particles in the dispersion of the ink compositions (IJ-18) to (IJ-21) are set forth in Table G.

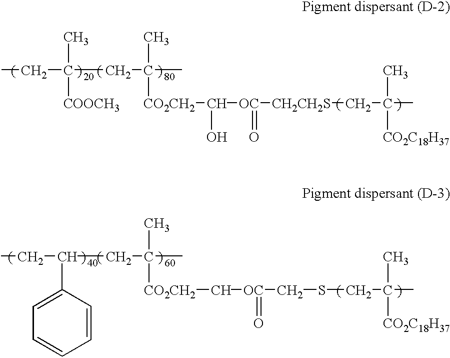

(The copolymerization ratio is represented by molar ratio)

TABLE G

| | | Volume-average |
|---|---|---|
| Ink | Pigment | particle diameter |
| composition | dispersant | (μm) |
| IJ-18 | P-7 | 0.24 |
| IJ-19 | P-5 | 0.26 |
| IJ-20 | D-2 | 0.27 |
| IJ-21 | D-3 | 0.23 |

The ink compositions (IJ-18) to (IJ-21) were each then evaluated for image quality in the same manner as in Example 1. All the ink compositions were stably ejected without nozzle clogging over an extended period of time and gave a definite image free of running and having a sufficient density and a good quality. It was also found that the image thus drawn is excellent in scratch resistance on the solid image area. The ink compositions (IJ-18) to (IJ-21) showed no sedimentation and agglomeration even after prolonged storage and hence an extremely good dispersibility.

While the fact that the ink composition of the invention is useful as an oil-based composition for ink jet printer has been described with reference to piezo process, the invention is not limited thereto. The invention can be applied to electrostatic ink jet printer such as slit jet of Toshiba, NTT, etc., and thermal process ink jet printer.

The ink composition comprising the binder resin made of the graft copolymer of the invention can provide an oil-based composition for ink jet printer which has pigment particles finely dispersed therein and exhibits an excellent pigment dispersion stability. Further, an oil-based composition for ink jet printer having a high ejection stability which causes no nozzle clogging can be provided. Moreover, an oil-based composition for ink jet printer can be provided which exhibits an excellent dryability on the recording paper and gives a recorded image having an excellent water resistance and light-resistance and a high scratch resistance. Further, an oil-based composition for ink jet printer canbe provided which allows printing of a number of sheets of printed matter of good and sharp color image having no running.

This application is based on Japanese Patent application JP 2002-201431, filed Jul. 10, 2002, the entire content of which is hereby incorporated by reference, the same as if set forth at length.

What is claimed is:

1. An image forming method comprising ejecting an oil-based ink composition, the ink composition comprising:
a non-aqueous dispersion medium;
a coloring material; and
a binder resin comprising a graft copolymer,
wherein the graft copolymer comprises a monomer constituting a main chain moiety soluble in the non-aqueous dispersion medium and a macromonomer constituting a graft moiety insoluble in the non-aqueous dispersion medium.

2. The image forming method according to claim 1, wherein the monomer is represented by the following formula (III), and the macromonomer has a weight-average molecular weight of from 1×10³ to 4×10⁴, has a chain comprising at least one of repeating units represented by the following formulae (IIa) and (IIb), and has a polymerizable double bond represented by the following formula (I) at one end of the chain, with the proviso that the chain is insoluble in the non-aqueous dispersion medium: 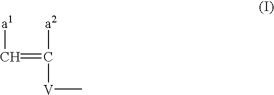
wherein V represents —COO—, —OCO—, —(CH₂)ₙ—OCO—, —(CH₂)ₙ—COO—, —O—, —CONHCOO—, —CONHCO—, —SO₂—, —CO—, —CON(Z¹)—, —SO₂N(Z¹)— or phenylene group which may be 1,2-, 1,3- or 1,4-phenylene group, Z¹ represents a hydrogen atom or a hydrocarbon group, and n represents an integer of from 1 to 3; and a¹ and a² each independently represents a hydrogen atom, a halogen atom, a cyano group, a hydrocarbon group, —COO—Z² or —COO—Z² having a hydrocarbon group incorporated therein, and Z² represents a hydrogen atom or a hydrocarbon group; 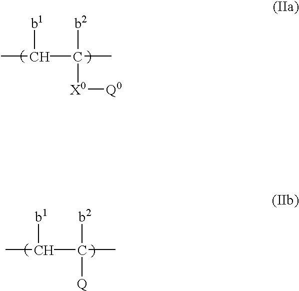
wherein X⁰ represents at least one connecting group selected from —COO—, —OCO—, —(CH₂)ₘ—OCO—, —(CH₂)ₘ—COO—, —O—, —CONHCOO—, —CONHCO—, —SO₂—, —CO—, —CON(Z³)— and —SO₂N(Z³)— in which Z³ represents a hydrogen atom or a hydrocarbon group, and m represents an integer of from 1 to 3; b¹ and b² each independently represents a hydrogen atom, a halogen atom, a cyano group, a hydrocarbon group, —COO—Z² or —COO—Z² having a hydrocarbon group incorporated therein, and Z² represents a hydrogen atom or a hydrocarbon group; Q⁰ represents an aliphatic group having from 1 to 3 carbon atoms, a cycloalkyl group having from 3 to 8 carbon atoms or a crosslinked hydrocarbon group; and Q represents —CN or a phenyl group which may be substituted by a substituent selected from a halogen atom, an alkoxy group and —COO—Z⁴ in which Z⁴ represents a hydrogen atom, an alkyl group, an alkenyl group, an aralkyl group, an alicyclic group or an aryl group; 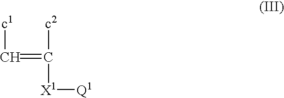
wherein X¹ represents —COO—, —OCO—, —(CH₂)ₙ—OCO—, —(CH₂)ₙ—COO—, —O—, —CONHCOO—, —CONHCO—, —SO₂—, —CO—, —CON(Z¹)—, —SO₂N(Z¹)— or phenylene group which may be 1,2-, 1,3- or 1,4-phenylene group, Z¹ represents a hydrogen atom or a hydrocarbon group, and n represents an integer of from 1 to 3; Q1 represents an aliphatic group having from 4 to 22 carbon atoms; and c¹ and c² each independently represents a hydrogen atom, a halogen atom, a cyano group, a hydrocarbon group, —COO—Z² or —COO—Z² having a hydrocarbon group incorporated therein, and Z² represents a hydrogen atom or a hydrocarbon group.

3. The image forming method according to claim 1, wherein the ink composition further comprises a pigment dispersant.

4. The image forming method according to claim 2, wherein the ink composition further comprises a pigment dispersant.

5. The image forming method according to claim 1, wherein the repeating unit is selected from the following formulae (A-1) to (A-7), in which b represents H or —CH₃; Q² represents a methyl, ethyl or propyl group; Q³ represents a halogen atom, an alkyl group, an aralkyl group, an alkoxy group or —CO₂—Z³, and Z³ represents a hydrogen atom or a hydrocarbon group; and Q⁴ represents an alkyl group having from 1 to 12 carbon atoms:

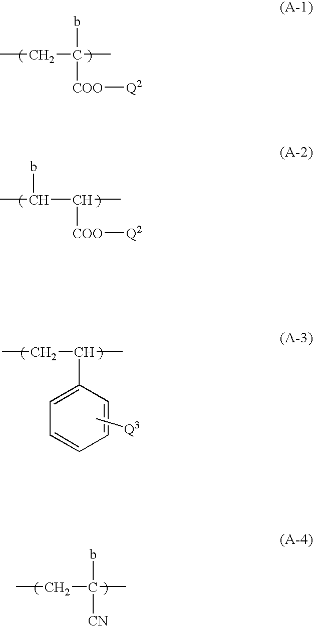

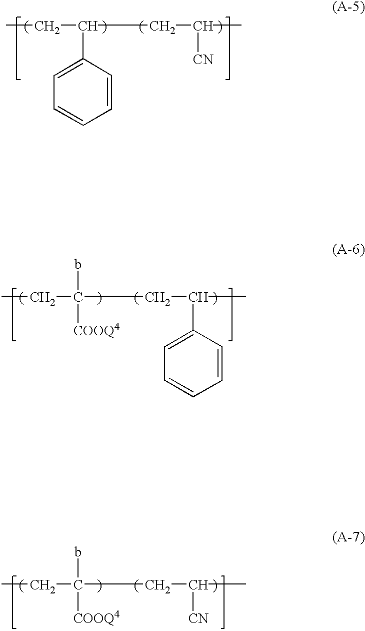

6. The image forming method according to claim 1, wherein the non-aqueous dispersion medium is a non-polar insulating solvent.

7. The image forming method according to claim 2, wherein the non-aqueous dispersion medium is a non-polar insulating solvent.

8. The image forming method according to claim 1, wherein the non-aqueous dispersion medium has a dielectric constant of from 1.5 to 20.

9. The image forming method according to claim 1, wherein the non-aqueous dispersion medium has a surface tension of from 15 to 60 mN/m at 25° C.

10. The image forming method according to claim 1, wherein the graft copolymer has a number-average molecular weight of from 3,000 to 500,000.

11. The image forming method according to claim 2, wherein the graft copolymer has a number-average molecular weight of from 3,000 to 500,000.

12. The image forming method according to claim 1, wherein the graft copolymer has a number-average molecular weight of from 10,000 to 200,000.

13. The image forming method according to claim 2, wherein the graft copolymer has a number-average molecular weight of from 10,000 to 200,000.
